(19) United States
(12) Patent Application Publication
(10) Pub. No.: US 2007/0150091 A1
(43) Pub. Date: Jun. 28, 2007

(54) Electronic sock sorting and mating system

(76) Inventor: John Philip Griffits, TALLAI (AU)

Correspondence Address: JOHN PHILIP GRIFFITS, 99A TALLAI RD., TALLAI, 4213, AU

(21) Appl. No.: 10/598,165

(22) PCT Filed: Feb. 27, 2005
(86) PCT No.: PCT/AU05/00256

§ 371 Date: Aug. 20, 2006

(30) Foreign Application Priority Data
Feb. 27, 2004 (AU) 2004900992

(51) Int. Cl. G06F 7/00

(52) U.S. Cl. 700/215

(57) ABSTRACT

An organizing apparatus for sorting and mating members (1) of a plurality of members, the mated members forming a matched set. A preferred application is to sort socks (1). The invention comprises indicia (14) and electronic devices (3) preferably attached to each member (1) of the matched sets; a means to read said indicia (11) that may be human, or an electrically operated device (11); and a means to associate said read information with areas on a sock storage devices. Said association preferably includes the use of electrically operable indicator means (e.g. LED) attached to said sock storage device. The sock storage preferably may be temporary storage for the purpose of sorting/mating socks and/or for storage of socks for subsequent use. Means for automatically tracking the contents of luggage is disclosed.

The present invention seeks to describe an electronic and/or other automated method and apparatus for sorting and/or mating members of a plurality of members, the mated members forming a matched set. A non-limiting preferred application is the sorting of two or more socks into their respective pairs. Said sorting and mating preferably includes human input. The invention preferably has particular application for socks in a user environment, where the socks in one at least pairs may no longer be clearly associated with each other, e.g. as in a basket of washing. One at least embodiments of the invention preferably includes one at least of:—a) Sock ID Means (preferably human and/or machine readable); b) Sock Storage Means (preferably facilitated by electronic and/or other automated means); c) Sock Control Means (preferably using electronic and/or other automated means) to facilitate the sorting and/or mating and/or the storage of socks.

Terminology:

The use of one at least examples, preferably should be understood as meaning ‘one at least non-limiting example(s)’. The use of one at least examples in this specification preferably does not necessarily imply that said examples are essential to the invention, and/or preferably that said one at least examples (unless otherwise documented) are the preferred means. Furthermore, preferably when a plurality of examples are described it should be understood that in preferably one at least embodiment, none of said plurality may be used; and/or that in one at least embodiment preferably one at least of said plurality may be used. It should also be understood that the use of the singular of a word and/or phrase preferably may also be understood to reference the plural; and use of the plural preferably may be understood to reference the singular, where appropriate in the context used.

The invention preferably allows that it may be used in part at least in commercial settings and/or may be applied to the processing of information coupled to one at least other household items in a communal setting or otherwise. The invention is preferably not limited to pairing socks and preferably may be used to sort and/or mate other groups of garments e.g. gloves. While the specification may refer to pairs of socks (and/or other garments), the invention is preferably not limited to a pair of two, and is preferably not limited numerically. As a non-limiting example, one may have two pairs of identical socks and link them as a common group of four. In another non-limiting example, one sock from a group of four identical units may be lost with a residual group of three that may share a common group coding.

Description:

It is a preferred non-limiting objective of the invention to allow for part at least, of one at least of the following claims to form part of the description of the present invention.

A preferred non-limiting objective of the present invention is to describe means to couple information to each member of one at least pairs of socks, for example, wherein said information may be accessed and/or processed using electronic means. Said information preferably includes means to facilitate mating of a first sock in said pair with a second sock in said pair.

One problem when sorting and/or mating socks may be readily distinguishing the matching members of a pair. Socks with fairly distinctive patterns and/or colours may be easy to associate with one another. However, socks of similar appearance may be difficult to associate with matching members—for example a drawer of blue socks (especially when they have faded with age) may look similar on examination. This is a problem known to the art, and prior art describes means to more readily associate matching members of a pair of socks (e.g. fixing matching coloured threads to members of a pair, with said colour different to that applied to one at least other pairs of socks). The present invention preferably allows for the coupling of one at least Sock ID Means to preferably each sock in at least one pair of socks, wherein said identification means preferably may be read and/or otherwise acquired by electronic means and part at least of said acquired information may be used to facilitate mating of a first sock in a pair with a second sock in said pair.

The coupling of one at least Sock ID means to one at least socks preferably may include reversible coupling means.

The invention preferably may be applied to socks in a post-purchase scenario—e.g. a basket of washing with a plurality of socks belonging to a plurality of pairs.

The invention preferably may be applied to plural pairs of socks.

One at least Sock ID Means is preferably applied to the outside of one at least socks. The position of one at least Sock ID Means on the outside surface of one at least socks is preferably a non-limiting example of a means to identify whether or not a sock is inside-out.

The Sock ID Means is preferably unique for each particular sock and/or pair of socks. The Sock ID Means preferably may be constructed from materials that may include plastic and/or ‘glow in the dark means’.

The Sock ID Means preferably includes one at least of the following means:—
a) Non-electronic Sock ID Means that preferably may be read electronically. Non-limiting examples preferably may include the use of i) bar codes, and/or ii) indicia means, and/or iii) shapes and/or iv) colours.
b) Electronic Sock ID means. Non-limiting examples preferably may include RFID transponders and/or Dallas ‘Onewire’ ID means (e.g. Dallas DS2405). Said Electronic Sock ID Means preferably includes at least one digital code of at least one bit length.

One at least Sock ID Means preferably may be coupled to one at least socks using one at least known art means. One at least Sock ID Means is preferably waterproof and/or preferably able to withstand machine washing.

One at least Sock ID Means preferably may be coupled to one at least socks at any time in the lifecycle of said socks. This may include, as non-limiting examples, during manufacture, and/or by the distributor, and/or by the retailer and/or by the end user.

One at least Sock ID Means preferably may be supplied coupled to one at least socks; and/or sold uncoupled to one at least socks; and/or sold as a separate item that may be coupled to one at least socks and/or other means. It is preferable that one at least Sock ID Means may be applied to one at least socks outside the shoe contact area (e.g. the part of the sock nearest the sock opening that is normally covered by the trousers during use).

The coding used for one at least Sock ID means is preferably not limited. For example, to prevent and/or reduce the inadvertent duplication and/or production of a sequence of similarly appearing human readable indicia means on plural Sock ID Means, it is preferable that the invention may include an electronic storage means to record one at least coding means available for use and/or previously used. If a particular embodiment of the invention may require the reading of one at least indicia means by a human, it is preferable that matching socks in a pair have the same visible coding means (e.g. same indicia, colours, shapes). It is preferable that said visible coding means is distinct to that on other pairs of socks in the possession of a consumer, as far as practical. It is preferable that said electronic storage means is an electronic database. An example of facilitating the provision of human readable Sock ID means that are visibly distinct from each other, may be to provide a manufacturer and/or consumer with plural Sock ID means that may be distinguished by a representative selection of available code means (e.g. colours, shapes, indicia). This preferably reduces the chance of a consumer receiving a group of Sock ID Means that to the human eye may appear similar and difficult to differentiate. For manufacturers equipping their socks with ID Means prior to sale it preferably reduces the probability of a manufacturer producing batches of socks with sequentially similar appearing codes. A non-limiting preferred means of producing human readable Sock ID Means may be to select the codes (e.g. indicia, colours, shapes) at random from available combinations during the process of producing said Sock ID Means. It is preferable that when identical indicia are to be applied to each member of a pair of socks, two indicia means may be prepared with the same coding. It is preferable that when a particular code arrangement is selected that an electronic record is kept of its usage. It is preferable that there is limit means that records the number of times one at least code arrangements may be used. Said limit means is preferably electronically stored. It is preferable that on a temporary basis at least, there is a limit detection means that may prevent the production of code arrangements that have reached said limit. The manufacturer of the device preferably codes electronic Sock ID means. They preferably use 64 bit codes or longer, that in practice may be expected to provide each user with unique Sock ID Means for each sock they use.

The use of the Sock ID Means described for the present invention preferably facilitates the identification of the two socks comprising one at least pairs and said facilitation is preferably enhanced by electronic processing means described in this specification.

One issue when mating socks using known art means may be what to do with a sock while sorting through other socks seeking the matching pair(s).
One example of known sorting and/or mating means may be to select a sock, hold onto it (or place it at a storage location e.g. the bed, a bench, a table, the floor) and compare it with one at least subsequent (and/or previously examined) socks seeking the matching pair.
Another example of known art sock sorting and/or means, that may be particularly applicable to sorting socks into multiple pairs, may include the placement of one at least first socks in a pair at said storage location and likewise with the first sock of one at least other pairs. Each time the next sock is chosen for initial examination, the person sorting the socks may need to visually scan the already examined socks and check if said next sock is a first sock in a pair or the matching member of a sock already examined. It may be that said matching member is not located (e.g. it may not have been washed with the first member of said pair, and/or the dog may have destroyed said matching pair). When examining one at least socks, one may remember previously examining a matching sock and if the affirmative, assume that the present sock under examination is a matching pair for a sock already placed at said location. The next step may be to visually inspect socks previously placed at storage location, looking for the correct match. If the human sock sorter was mistaken in their recall, they may have wasted time. If said sock sorter determines from memory, that the matching pair for said next sock chosen for initial examination has not been previously examined, they may place said sock chosen at said storage location on the assumption that it is the first sock in a pair. If the said assumption is incorrect, the two socks in a pair may be placed separately at said storage location. In practice it may be difficult to remember if a matching sock has been examined previously and/or where it has been placed after examination.
Each sock in one at least pairs of socks are preferably fitted with a Sock ID Means and this preferably facilitates user recognition of matching pairs, a process that may be enhanced by the use of electronically readable Sock ID Means.

The use of machine means (e.g. RFID reader) to read sock ID's as described in the present specification, may facilitate the sorting and/or mating of socks. For example, a person may electronically read the sock ID of the present sock under examination and then electronically scan those previously examined and placed at said storage location to determine if there is a match. In another non-limiting example embodiment, electronic Sock Control Means preferably may have recorded if a matching member of the pair has been examined previously. The use of electronic sock ID means may facilitate, as a non-limiting example, a person determining if a current sock under examination is the first member of a pair, or whether they need to re-examine previously examined socks to find the other member of the pair.

Although electronic acquisition of Sock ID Means may augment the sock sorting and/or mating process, it is clear that present methods of storing previously examined socks while waiting to find the matching member of a pair is sub-optimal and may require the person sorting socks to repeatedly examine (manually and/or electronically) socks previously examined in the current sorting cycle. To preferably overcome some of the problems with the known art of storing socks during the sorting and/or mating process, it is a non-limiting preferred objective of the present invention to describe one at least Sock Storage Means to preferably facilitate placement of socks when sorting into pairs (as a preferably non-limiting function). One at least Sock Storage Means preferably may include plural discrete physical means (e.g. a first sock container means and a second sock container means).

The invention preferably allows for one at least Passive Sock Storage Means and/or one at least Active Sock Storage Means. Said active storage preferably includes electronic means. One at least Sock Storage Means preferably may include temporary storage functions (as a non-limiting example to facilitate sock sorting and/or mating). One at least Sock Storage Means preferably may include extended storage functions (e.g. a sock receptacle for socks between usage).

The prior art of storing socks during collation (and/or afterwards) relies on the human sorter to decide where to place socks pending sorting and/or mating. This may be a random decision. The sorting and/or mating of socks may be facilitated by the provision of one at least, preferably pre-determined, Sock Location Means that a human sock sorter (and/or other means) may be directed and/or elect to place one at least socks. One at least Sock Storage Means preferably may include one at least Sock Location Means. It is preferable that one at least Sock Location Means is coupled to one at least Sock Location ID Means to preferably identify said Sock Location Means. It is preferable that one at least Sock Storage Means includes Sock Retrieval Means to facilitate retrieval of one at least pairs of socks.

One at least Sock Location ID Means preferably may include human readable means, that as an example may include one at least of indicia, shapes, colours. For example, a Sock Storage means may include a relatively flat surface that has been visibly divided into a plurality of squares arranged horizontally and/or vertically. This may also be referenced as the Grid Sock Storage Example in this specification. For example, the horizontal squares may each be identified by a unique letter of the alphabet and the vertical squares may each be identified by a unique number—an example that preferably provides each square with a unique alphanumeric address. This may also be referenced as Alphanumeric Grid Sock Storage Example in this specification.

For example, a first square (and/or other Sock Location Means) may be the destination of one at least first and/or second socks in a first pairs of socks; and a second square (and/or other Sock Location Means) may be the destination of one at least first and/or second socks in a second pair of socks.

One embodiment of the invention preferably allows that sock sorting and/or mating may not include machine means—for example, each member of a pair of socks may be fitted with a human readable Sock ID Means (e.g. a fabric tag) that has an alphanumeric indicia preferably equivalent to one at least Sock Location ID Means (e.g. the alphanumeric Sock Location ID Means of said Alphanumeric Grid Sock Storage Example). For example, when sorting socks the operator preferably examines (e.g. visually) said Sock ID Means and looks for the equivalent Location ID Means coupled to the Sock Storage Means. If a positive comparison ensues, said operator preferably may place said sock at the Sock Location Means indicated by said alphanumeric Location ID Means. In this example embodiment, reading the Sock ID Means and the Sock Location ID means are both passive processes. Preferably the operator continues placing socks using this example process for a plurality of socks (e.g. a washing basket of socks). At the end of the process, matching pairs of socks are preferably clearly associated with each other (e.g. at the same Sock Location Means). This example preferably eliminates or reduces the need to compare a first sock with a second sock, and/or to handle one at least socks a plurality of times in the sorting and/or mating process. A limiting process with the present example may be that the Sock Storage Means may only be useful with socks that include a human readable Sock ID Means equivalent to the corresponding Location ID Means coupled to said Sock Storage Means. The sock storage means may need to be extensive to accommodate the requisite number of socks. It may also be problematic when it comes to including new pairs of socks in the process. It may also be inefficient, as only part of the resources of the Sock Storage Means may be required in a particular sorting and/or mating cycle.

It is preferable that one at least Sock Storage Means may include means to facilitate the sorting and/or mating of socks that may be worn by a plurality of humans. For example, in the preceding example the left half of the Sock Storage Means may be for socks belonging to a first person in a family and the right hand side for socks belonging to a second family member.

One at least Sock Location Means, referenced as the Untagged Sock Location Means (e.g. one at least predetermined Sock Location Means in the preceding alphanumeric grid sock storage example), preferably may be a destination for one at least socks that is not equipped with part at least of a Sock ID Means.

One at least Sock Location Means, referenced as the Orphan Sock Location Means (e.g. one at least predetermined Sock Location Means in the preceding alphanumeric grid sock storage example), preferably may be a destination for one at least socks that temporarily at least, may be unable to be sorted and/or mated with the other member of the pair.

One at least Sock Location Means, referenced as the Invalid Sock Location Means (e.g. one at least predetermined Sock Location Means in the preceding alphanumeric grid sock storage example), preferably may be a destination for one at least socks that is equipped with a Sock ID Means that is not able to be validated by one at least appropriate Sock Control Means.

One at least Sock Location Means preferably may be the destination for a pair of socks. One at least first Sock Location Means preferably may be the destination for a first sock in a pair, and one at least second Sock Location Means preferably may be the destination of a second sock in said pair. One at least Sock Location Means preferably may be the destination for a plurality of pairs of socks. One at least Sock Location Means preferably may be the destination for a plurality of socks that are not members of the same pair. If sock belonging to different pairs of socks are to be stored at the same Sock Location Means, it is preferable that one at least socks from a first pair is distinct to the human observer (e.g. a first distinct colour) to one at least socks from a second pair of socks (e.g. a second distinct colour).

The shape of one at least Sock Location means is preferably not limited. The surface arrangement of one at least Sock Location Means is preferably not limited (for example, said Sock Location Means preferably may be relatively flat as described for the Grid Sock Storage Example, and/or a three dimensional structure as may be found in a sock storage container means (e.g. one at least wire baskets and/or receptacle means for one at least pair of socks). The spatial arrangement of one at least first Sock Location Means relative to one at least second Sock Location Means is preferably not limited. One at least Sock Location Means preferably may be grouped with one at least other Sock Location Means.

One at least Sock Storage Means preferably may be portable.

Non-limiting examples of Sock Storage Means preferably may include one at least of:—
one at least container means that fits into one or more drawer means (e.g. drawers used in bedside tables and/or wardrobes and/or walk-in robes;
one at least container means that, in part a least, includes a drawer means.
one at least Surface Means (e.g. blanket, bedspread, doona cover, mat).

Non-limiting examples of means used to construct one at least Sock Storage Means preferably may include one at least of the following: i) Timber; ii) Plastic; iii) Metal; iv) Plastic coated wire; v) Fabric.

The invention preferably allows that one at least Sock Location Means is preferably associated with one at least Indicator Means. One at least Indicator means is preferably an Illumination Means. A non-limiting example of an Illumination Means is preferably one at least LED's of one at least colours. One at least Indicator Means preferably may be activated (e.g. one at least LED's illuminated) and one at least Indicator Means preferably may be inactivated (e.g. one at least LED's switched off). It is preferable that one at least Indicator Means may be used to facilitate directing one at least socks to one at least Sock Location Means.
For example, a user may use electronic means (e.g. Sock Control Means described below) to read the electronic Sock ID's coupled to a first sock, electronic processing of this information preferably may follow, a first Indicator Means preferably may illuminate and the user preferably may place said first socks at the Sock Location Means associated with said Indicator Means.

One at least Indicator Means are preferably clearly associated, to human visual inspection (as a non-limiting example), with one at least Sock Location Means.

One at least Indicator Means preferably may be addressed by electronic means. Said addressing preferably facilitates activation and/or inactivation of said Indicator Means. One at least Indicator Means preferably includes a time-out means to inactivate said indicator means after a preferably predetermined (and preferably user programmable) interval.

One at least Sock Storage Locations is preferably coupled to a Vacant Sock Location Detector Means. Non-limiting examples of said Vacant Sock Location Detector Means preferably may include one at least of:—
i) electro-mechanical detection means, for example, the presence of one at least socks in one at least Sock Storage Means preferably may open an electrical circuit to indicate the presence of said one at least socks, and a closed electrical circuit preferably indicates a vacant Sock Location Means. The invention preferably allows that the presence of one at least socks in one at least Sock Storage means may close an electrical circuit to indicate the presence of said sock, and an open electrical circuit preferably indicates a vacant Sock Location Means.
ii) light emitter detector means, for example, the presence of one at least socks in one at least Sock Location Means preferably may interrupt light from an emitter means (e.g. infrared LED) to a photo-detector (e.g. PIN Diode) indicating the presence of one at least socks. An uninterrupted light beam preferably may indicate a vacant Sock Location Means.
iii) one at least image detection means (e.g. CMOS digital imaging and processing means) preferably may be used to image one at least Sock Location means and preferably facilitate determining which (if any) Sock Location Means are presently vacant.
iv) reset means wherein one at least electronic means (e.g. Location Control means described below) is advised by the user (e.g. pushing reset button, display menu selection) that one at least Sock Location Means is vacant.

One at least Vacant Sock Location Detector Means preferably interfaces to an electronic processing means.

The invention preferably includes a Location Control Means that include one at least electronic means to facilitate storage of socks and/or retrieval of socks, Said Location Control Means preferably may address and/or otherwise influences one at least Indicator Means using electronic means. Said Location Control Means preferably may address and/or read and/or influence one at least vacant Sock Location Detector Means using electronic means. It is preferable that one at least Location Control Means may be reset in part at least. One at least Location Control Means preferably may activate one Indicator Means at a time. One at least Location Control Means preferably may activate a plurality of Indicator Means concurrently.
As non-limiting examples, one or a plurality of Indicator Means preferably may be activated to indicate for example, part or all sorted and/or mated pairs of socks belonging to a first person, and/or one or a plurality of Indicator Means preferably may be activated to indicate for example, part or all sorted and/or mated socks belonging to a second person. As a non-limiting example, one or a plurality of Indicator Means preferably may be activated to indicate for example, Sock Location Means that include one at least Orphaned Socks. As a non-limiting example, one or a plurality of Indicator Means preferably may be activated to indicate for example, Sock Location Means that include one at least Untagged Socks.

One at least Indicator Means preferably may be used to facilitate retrieval of one at least socks from one at least Sock Location Means. Said retrieval is preferably facilitated by one at least Location Control Means. As a non-limiting example, a user may input a request to an electronic means (e.g. a Sock Control Means described below) to locate a pair of red socks belonging to said user. Said Location Control means preferably may activate one at least Indicator Means to guide the user to one at least pairs of socks meeting the input request parameters.

One at least Location Control Means preferably may be programmed with the electronic address (e.g. address of one at least Indicator Means and/or Vacant Sock Location Detector Means) of one at least Sock Location Means used by a first sock user. One at least Location Control Means preferably may be programmed with the electronic address (e.g. address of one at least Indicator Means and/or Vacant Sock Location Detector Means) of one at least Sock Location Means used by a second sock user.
As a non-limiting example a first drawer means (e.g. that fits into a bedside table) may include a number of internal partitions with each partition preferably representing a Sock Location Means, and said first drawer may belong to a first member of a family, and a second drawer means (e.g. that fits into a bedside table) may include a number of internal partitions with each partition preferably representing a Sock Location Means, and said second drawer may belong to a second member of a family. One at least Location Control Means preferably is coupled to memory storage means that may associate one at least electronic addresses coupled to said first drawer with said first family member, and may associate one at least electronic addresses coupled to said second drawer with said second family member.

It is a preferred objective of the present invention to include electronic means for processing one at least Sock ID means and/or electronic means to facilitate the functions of one at least Sock Storage Means.

A preferred non-limiting objective of the present invention is to describe Sock Control Means to electronically process information preferably coupled to each member of one at least pairs of socks. Said information preferably includes means to facilitate sorting and/or mating of a first sock in said pair with a second sock in said pair, and preferably a method to utilise Sock ID Means to provide an electronic means to facilitate collating pairs of socks.

One at least functions described for one at least Sock Control Means preferably may be included in one at least Location Control Means. One at least functions described for one at least Location Control Means preferably may be included in one at least Sock Control Means. One at least means to communicate between one at least Sock Control Means and one at least Location Control Means preferably may include the following examples:—RF wireless (e.g. Zigbee, RFID, Bluetooth, 802.11), Infrared wireless (e.g. IrDa), wired (e.g. electrically conductive, fibre optic).

A co-pending application by the present inventors titled “Identification and selection of keys for use with locks” being PCT AU03/01029 describes a portable RFID and/or ‘onewire’ reader that as a non-limiting example may be embodied in a key fob. This specification is incorporated by way of reference into the present description. The Key Control Means of AU03/01029 preferably may provide a non-limiting example of a means of implementing part at least of the means described for the present invention, in particular, part at least of the means of one at least Sock Control Means and/or Location Control Means.

One at least Sock Control Means preferably may include one at least of the following example means:—
1) preferably may receive, as non-limiting examples, a) Sock ID information; and/or b) Sock_ID Support information; and/or c) Commands and/or Instructions and/or Data; and/or d) Sock Sorting and/or mating information; and/or e) Sock Storage Information.
2) preferably may output as non-limiting examples a) means to facilitate modification of electronically stored information in one at least electronic Sock ID Means; and/or b) commands and/or instructions and/or other information and/or data; and/or c) sock information and/or sock sorting and/or mating and/or sock storage information.
3) preferably includes computer programs and/or data that may facilitate part at least of the means described for the present invention, and said programs and/or data are preferably stored in one at least computer readable media.
4) preferably includes means to a) load programs and/or data into said SCM and/or b) edit and/or remove programs and/or data.
5) preferably includes means to transfer information to and/or from one at least other electronic data processing means, non-limiting examples of said data processing means preferably may include:—i) one at least other SCM, and/or ii) one at least User Controlled data Processing System (e.g. PC); and/or iii) Internet based means; and said transfer preferably may include backing up data stored within said SCM and/or transferring information into said SCM.
6) preferably includes information input means that as non-limiting examples preferably may include i) voice input information; and/or ii) keyed information; and/or iii) pointer device input information; and/or iv) menu selection from a display means; and/or v) wireless information (e.g. preferably one at least of zigbee, bluetooth, infrared, RFID); and/or vi) via conductive means (e.g. accessing Dallas Semiconductors Onewire means).
   As a non-limiting example of a means for a user to enter information (e.g. a command) into one at least SCM, the invention preferably allows for the length of time and/or number of times, one at least first electronic input and/or output means (e.g. RFID reader) may access (e.g. read) one at least second electronic input and/or output means (e.g. RFID transponder). This is referenced as Modulated Reader Input. For example the user may continually scan an RFID tag for more than one second (for example) to indicate a first command input and less than a second (for example) to indicate a second command input. The invention preferably allows for a flashing illumination means (e.g. LED on enclosure of one at least SCM) to facilitate user timing of said Modulated Reader Input.
   The invention preferably allows for Modulated Reader Input (MRI) means to be used with other RFID and/or other electronic processing mean. For example, said MRI preferably may be used with one at least Key Control Means (pending PCT AU 03/01029 by the present inventors, that is incorporated into this specification by way of reference) and/or Remote Undressing Means (pending WO 04/000050 by the present inventors, that is incorporated into this specification by way of reference).
7) preferably includes information output means that as examples, preferably may include i) display means (e.g. LCD, OLED's), and/or ii) sound (e.g. speaker means), and/or iii) RF (e.g. Zigbee, WiFi 802.11, Bluetooth, RFID), and/or iv) infrared (e.g. IrDa), and/or v) optical (e.g. one at least LED's), and/or vi) conductive means.
8) preferably includes electronic processing means (e.g. Motorola MC9S08GB) and/or memory storage means (preferably flash and/or other non-volatile memory in part at least).
9) preferably includes one at least of the following functions:—
a) Sock ID Acquisition Means (SIDAM) that preferably includes electronic processing means, and electronic memory storage means (preferably non-volatile in part at least), and that preferably may read and/or otherwise acquire into said memory storage means information pertaining to one at least Sock ID Means. Said SIDAM preferably may write information to one at least electronic Sock ID Means. A preferred non-limiting example of an acquisition means is to use an RFID reader means coupled to said SCM, to read ID information from RFID transponders coupled to one at least socks.
   i) The Sock ID Acquisition Means preferably may be initialised with Sock ID information for at least one sock in at least one pair of socks. Said SIDAM preferably may be initialised with Sock ID information pertaining to a plurality of socks, and preferably a plurality of pairs of socks. Said initialisation of information preferably may be time independent for at least one Sock ID means compared to one at least other Sock ID Means. Said initialised information preferably facilitates identification of a first and second sock of one at least pairs of socks. Said initialised information is preferably arranged such that said processing means may electronically associate said first sock ID with said second sock ID. The means of electronically associating Sock ID means of a matching members of at least one pair of socks is referenced as a Paired Sock ID Library Means. The invention preferably allows for means to edit the information in said Paired Sock ID Library Means.
   ii) It is preferable that Sock ID information stored in and/or otherwise coupled to one at least SIDAM and/or Paired Sock ID Library may facilitate reference to other electronically stored information referenced as Sock ID Support Information, that preferably may be used by one at least functions of the SCM and/or preferably may be output in response to one at least user commands. Non-limiting examples of said support information preferably may include one at least of a means to identify the:—
      colour (and/or range of colours) of one at least socks (Sock_Colour);
      size of one at least socks (Sock_Size);
      pattern of one at least socks (Sock_Pattern);
      the age of one at least socks (Sock_Age);
      sex of the user of one at least socks (Sock_User_Sex);
      the age of the user of one at least socks (Sock_User_Age);
      name (and/or other ID) of the user of one at least socks (Sock_User_Name);
      location that one at least socks was previously stored at (Sock_Old_Location);
      location that one at least sock may be placed during the next and/or current sorting process (Sock_New_Location);
      frequency and/or time that one at least socks is worn between wash cycles (Sock_Usage);
      type of sock e.g. sports sock, school sock, dress sock (Sock_Type)

A non-limiting preferred method of initialising Sock ID information into one at least Sock Control Means may include one at least of:—
a user purchases one at least pairs of sock re-equipped with Sock ID Means, enter appropriate command into said Sock Control Means to read Sock ID of first sock in said pair, then enter command to read the Sock ID of the second sock in the pair and then a command to associate the two Sock ID's as matching members of said pair (said associate command preferably may be integral with one at least of the commands to read one at least Sock ID's.
user obtains (e.g. purchases) two at least Sock ID means and attaches them to one at least pairs of socks and initialises one at least Sock Control Means with said Sock ID Means (e.g. as described in (a) above).
user obtains (e.g. purchases) preferably two at least Sock ID means and initialises one at least Sock Control Means with said Sock ID Means (e.g. as described in (a) above) and then preferably attaches a Sock ID Means to each sock in at least one pair.

One at least sock support information preferably may be entered into one at least Sock Control Means, as a non-limiting example, preferably when initialising said Sock ID information.
b) Active Sock Processing Means that preferably facilitates one at least of the following non-limiting preferred functions:—
   i) determines activation of a new sorting and/or mating session (e.g. a new basket of washing), non-limiting examples of said activation preferably may be in response to power-up of the SCM and/or key entry and/or voice command as non-limiting examples.
   ii) initialise registers and memory locations.
   iii) in response to one at least input activation signal (e.g. one at least of key(s) press, menu selection, voice command, auto detect of RFID Transponder signal) the SCM preferably may read part at least of a Sock ID means, referenced as Current_Sock ID mean into one at least memory storage addresses—referenced as Temp_Current_Sock_ID register. This is preferably the Sock ID belonging to the current sock that one wants to process for sorting and/or mating and/or storage.
   iv) a Current_Sock_Validation Means that preferably examines the Paired Sock ID Library Means and verifies whether or not the sock identified by Temp_Current_Sock_ID has an entry in said Paired Sock ID Library Means.
   v) Invalid_Sock_ID means that preferably in response to an Invalid Sock ID Code, preferably may facilitate one at least of the following non-limiting functions—
      preferably may advise the user that the SCM does not have a prior record of this sock ID. Said advised is preferably by display means (e.g. message on LCD or OLED means), and/or speaker means, and/or flashing one at least LED's.
      preferably may request user input on course of action.
      preferably may perform one at least predetermined actions.
      preferably stores the Sock ID as at least one entry in an Invalid Sock Library Means (this is preferably cleared if the Sock ID, as a non-limiting example, is eventually validated) that preferably logs a record of sock ID's that are not validated by the SCM.
      preferably may attempt an action that attempts to construct a valid Paired Sock ID Library entry (as a non-limiting example by attempting to obtain the data from a backup means—e.g. another SCM, and/or User Controlled Data Processing Means (e.g. PC), and/or Internet, and/or the user).
      preferably passes processing to a Sock Sorting and/or mating and Storage Processing Means (that preferably directs the user to store the sock in one at least Invalid Sock Locations that preferably may include other socks with invalidated Sock ID's, preferably facilitating the user manually and/or automatically locating the matching pairs and preferably updating the Paired Sock ID Library means).
      One at least Sock Control Means preferably includes a means (e.g. menu selection, key press) for the user to advise that one at least socks does not have a Sock ID Means. Said sock preferably may be stored in one at least Untagged Sock Locations. Processing is preferably then passed to one at least Sock Sorting and/or mating and Storage Processing Means.
      preferably clears the Temp_Current_Sock_ID register.
   vi) Valid_Sock_ID means that preferably in response to an Valid Sock ID Code, preferably may facilitate one at least of the following non-limiting preferred functions—
      may advise the user that the SCM has a prior record of this sock ID. Said advised is preferably by display means (e.g. message on LCD or OLED means), and/or speaker means, and/or flashing one at least LED's).
      may request user input on course of action.
      may perform one at least predetermined actions.
      may store the Sock ID as one at least entries in an Valid Sock Library Means that preferably includes a list of one at least Valid Sock ID's processed in the Current Sorting and/or mating Session.
      may pass processing to a Paired Sock Query Means.
      may clear the Temp_Current_Sock_ID register.
   vii) Paired_Sock Query Means (PSQM) that preferably may determine if a Sock ID that is a matching pair for Current_Sock ID has previously been processed. Said previously processed is preferably during the Current Sorting and/or mating Session.
      The preferred determination means is to search the Paired Sock ID Library Means for the Sock ID that is the matching pair (referenced as Current Matched Sock ID) for said Current Sock ID, and then search to verify if the Valid Sock Library Means includes an entry for said Current Matched Sock ID. The Sock ID for the first and second socks in a pair are preferably stored in said Valid Sock Library Means such that electronic processing means preferably may readily identify them as a member of a pair. The preferred method is to store the sock ID for a first sock in a first memory storage location and the sock ID for said second sock in a memory storage location with a preferably predetermined address offset from said first memory storage location. Said predetermined address offset is preferably the same byte offset for the second sock of any pair processed by said SCM. The Current Sock ID is preferably flagged as the first or second sock processed in a pair, with processing preferably passed to a Sock Sorting and/or mating and Storage Processing Means.
   viii) Sock Sorting and/or mating Criteria Determination Means that preferably facilitates determination of the sorting and/or mating criteria for the Current Sorting and/or mating Cycle. The invention preferably allows for one at least of the following non-limiting examples of sorting and/or mating criteria:—
      Single Pair Sorting and/or mating means wherein the user preferably may have a first sock in a pair and want to find the second sock of the pair. For example, this may apply if a user has a storage means (e.g. a drawer) including unsorted and/or mated socks, from which they have retrieved one sock and want to find the matching member of the pair. The preferred method is to read the Sock ID of the first sock, and then process subsequently read Sock ID's until the match (if any) is found. This means preferably utilises part at least of the means described for the present invention. The Single Pair Sorting and/or mating Means preferably may allow the user to self-determine where they place wanted and unwanted socks.
      Plural Pair Sorting and/or mating means wherein the user preferably may have a plurality of pairs of und socks, wherein they want to sort and/or mate plural pairs of socks in the Current Sorting and/or mating Cycle. This means preferably interfaces with automated means (as a non-limiting example, the SCSPM described subsequently in this specification) to facilitate directing one at least users to place one at least socks in one at least storage locations. This means preferably utilises part at least of the means described for the present invention.
   Examples of means of user selection between said Single Pair and Plural Pair Means preferably may include key board entry, and/or menu selection, and/or voice input, and/or Modulated Reader Input (e.g. read transponder for greater than 1.5 secs for Single Pair Means and less than 1 second for Plural Pair Means).
   ix) Sock Sorting and/or mating Start Means that preferably activates one at least Sock Control Means and/or Location Control Means to commence one at least functions. As a non-limiting example the press of a first key on one at least Sock Control Means may initiate a sock sorting and/or mating cycle. The press of a second key may initiate a sock retrieval cycle.
   x) Sock Sorting and/or mating Termination Means that preferably terminates one at least Sock Control Means and/or Location Control Means functions. As a non-limiting example, the press of a third key preferably may terminate processing, and/or blank the display, and/or force one at least processing means to enter a power down mode, and/or disconnect power.
   xi) Sock Sorting and/or mating and Storage Processing Means (SCSPM) that preferably may facilitate directing one at least socks to one at least Sock Storage Means, and/or Sock Location Means, and/or facilitate retrieval of one at least socks from one at least Sock Location Means. Non-limiting example functions of one at least SCSPM preferably may include one at least of:—
      For a first validated sock in a pair, preferably interfaces with one at least Location Control Means to facilitate determination of a suitable vacant Sock Location Means, and preferably direct said Location Control Means to activate the Indicator Means associated with said vacant Sock Location Means.
      For a second validated sock in a pair, preferably direct one at least Location Control Means to activate the Indicator Means associated with the Sock Location Means presently accommodating the first sock in said pair.
      Use one at least Sock ID Support Information to influence determination of one at least Sock Location Means that may be the target for one at least socks. As a non-limiting example, one at least SCSPM may use Sock_User_Name information to determine the potential wearer of the sock, and preferably interrogate one at least Location Control Means to determine one at least Sock Location Means suitable for said sock (e.g. a first drawer may be the destination for socks of said wearer and a second drawer may be the destination of socks for one at least other persons). The degree of said influence preferably may be influenced in part at least by information input to one at least Sock Control Means by one at least persons. As a non-limiting example, socks worn previously and not washed are preferably sent to one at least, preferably predetermined, Dirty Sock Location Means.
      For an invalidated Sock ID Means, preferably interface with one at least Location Control Means to determine a suitable target Sock Location Means, and preferably instruct said Location Control Means to activate the Indicator Means associated with said Sock Location Means.
      For an untagged sock, preferably interface with one at least Location Control Means to determine a suitable target Sock Location Means, and preferably instruct said Location Control Means to activate the Indicator Means associated with said Sock Location Means.
      Preferably maintain a History Database Means of the last address of one at least Sock Location Means, that one at least Socks (preferably tracked by its Sock ID Means) was previously stored. This is preferably updated in real time as socks are placed in Sock Location Means.
      May keep track of one at least orphan socks (e.g. the address of their associated Sock Location Means); and/or preferably access said History Database Means to determine (if possible) the last Sock Location Means said orphan sock and/or its pair was stored; and preferably instruct one at least Location Control Means to activate the Indicator Means coupled to said last Sock Location Means (e.g. to assist one at least persons to check said last Sock Location Means and determine if the missing member of the pair is there).
      Means to facilitate (e.g. instructing one at least Location Control Means) inactivation of one at least Indicator Means. As a non-limiting example, one at least Indicator Means is preferably activated to indicate the position of a target Sock Location Means and it is preferable that said activation time is limited such that said Indicator Means is inactivated when the next sock in the sorting and/or mating cycle is being processed. Non-limiting example means preferably may include a predetermined (and preferably user programmable) interval, and/or automatic inactivation when a next sock is processed, and/or under user control in part at least by one at least keys key coupled to one at least Sock Control Means.
      Means to move one at least socks from a first Sock Location Means to a second Sock Location Means. As a non-limiting example, a basket of socks may have been sorted onto a Grid Sock Means, and the members of each pair (for example) are to be transferred to a longer term Sock Storage Means (e.g. a drawer, preferably with plural partitioned areas, preferably one partitioned area for each pair of socks). One at least SCSPM preferably may instruct one at least Location Control Means to activate the Indicator Means for each pair of socks belonging to a first family member, and may further instruct said Location Control Means to flash the Indicator Means associated with a first pair of socks presently located in said first Sock Location Means (e.g. located on said Grid Sock Means) and preferably also instruct one at least Location Control Means to activate the Indicator Means coupled to said second Sock Location Means (e.g. one of said partitions in said drawer). One at least persons preferably may then readily identify the origin and destination of said first pair of socks for transfer.
      One at least persons preferably may input into one at least Sock Control Means, criteria information pertaining to one at least pairs of socks (e.g. colour, and/or age, and/or most recently washed) and one at least Sock Control Means preferably may instruct one at least Location Control Means to activate one at least Indicator Means associated with one at least Sock Location Means presently accommodating one at least socks meeting said input criteria.

The invention preferably allows for a means to maintain socks in a paired arrangement (preferably reversibly) after they have been sorted. The preferred method is to couple one at least first Sock Linking Means to the Sock ID means coupled to the first sock in one at least pairs, and a second Sock Linking Means to the second sock in one at least pairs, such that said first Sock Linking Means and said second Sock Linking Means may join together on a reversible basis. Said joining together is preferably functional when said first and second Sock Linking Means are coupled to Sock ID Means that are attached to their respective socks. Non-limiting examples of said Sock Linking Means preferably may include—i) a first Sock Linking means may be a magnet means that is preferably fabricated as part of one at least Sock ID Means and a second Sock Linking Means preferably may include a material that may be attracted to a magnet means that is preferably fabricated as part of one at least Sock ID Means; and/or ii) a first Sock Linking Means preferably may be a mechanical clasp means that preferably couples with a suitable slot means forming said second Sock Joining Means.

The invention preferably may be applied to tracking one at least Luggage Items (e.g. garments, toothbrush, razor, deodorant, diapers, documents, electronic means) in one at least Luggage Carrying Means (e.g. suitcase, briefcase, handbag, baby pack). As a non-limiting example, one at least Luggage Items are preferably coupled to one at least electronic Luggage ID Means, e.g. RFID Transponder. Said Luggage ID Means is preferably unique. One at least Luggage Carrying Means is preferably coupled to one at least electronic ID Means (e.g. RFID transponder), referenced as Suitcase ID Means. Said Suitcase ID Means is preferably unique.

One at least Luggage Control Means preferably may read the Luggage ID Means of one at least Luggage Items as they are packed into, and/or are contained within and/or removed from one at least Luggage Carrying Means. One at least Luggage Control Means preferably may read the Suitcase ID Means of one at least Luggage Carrying Means. One at least Luggage Control means preferably may associate one at least Luggage ID Means with one at least Suitcase ID Means.

There is preferably a means for one at least persons to request, as a non-limiting example, one at least Luggage Control Means to electronically verify that the contents of said Luggage Carrying Means is the same (or as otherwise modified) at a second point in time as at a first point of time (e.g. when departing home, for example). One at least Luggage Control Means preferably includes a means to provide one at least persons with a list of part at least of missing items, preferably in human usable format (e.g. list of description of said items in preference to a list of Luggage ID Means). One at least Luggage Control Means preferably includes a means to provide one at least persons with a list of part at least of packed items, preferably in human usable format (e.g. list of description of said items in preference to a list of Luggage ID Means).

The invention preferably allows for a means to inactivate part at least of one at least Sock ID, and/or Luggage ID, and/or Suitcase ID transponders. Said inactivation is preferably reversible. Said inactivation preferably may be applied to one at least RFID transponders used for one at least other purposes.

One at least Luggage Control Means preferably includes a means to input information (e.g. keyboard, menu based display means, voice). Said input information preferably may include, as non-limiting examples, one at least commands to:—i) read one at least Luggage ID Means (for example, when packing and/or to verify contents); and/or ii) verify that the contents of one at least Luggage Carrying Means is valid (e.g. one at least items is not missing); and/or iii) edit information coupled to one at least Luggage Control Means (for example, to delete one at least Luggage Items and/or to add one at least Luggage Items).

One at least Luggage Control Means preferably includes a means to store one at least Luggage ID Means in memory storage means coupled to said Luggage Control Means, preferably in an electronic database means.

One at least Luggage Control Means preferably includes a means to input descriptive information pertaining to one at least Luggage Items (Grey Woollen Jacket—Yvonne's) and preferably a means to associate said descriptive information with one at least Luggage ID Means, preferably in memory storage means accessible by said Luggage Control Means. One at least Luggage Control Means preferably includes a means to edit said descriptive and/or associative information.

One at least Luggage Control Means preferably includes a means to output information to one at least persons. Non-limiting examples of said output information preferably may include a list of luggage items in one at least luggage carrying means. Another output example preferably may include an alarm (e.g. visual and/or audible) if one at least luggage items remains unaccounted for.

The invention preferably allows that one at least Luggage Control Means preferably may be programmed with preferably a plurality of luggage items that one at least persons may wish to pack into their luggage when travelling (for example). Said programmed list is referenced as a Personal Selection Means. One at least Luggage Control Means preferably may monitor items as they are packed and advise one at least persons of any deficiency and/or excesses of luggage items. The invention preferably allows that one at least Personal Selection Means may offer options (for example a person may have four woollen jackets, however they may be prepared to take any two said woollen jackets). Said Personal Selection Means preferably may be edited and/or overridden by one at least persons (and/or other means). One at least Personal Selection Means preferably may include plural selections (e.g. a winter and summer selection—the user preferably may inform one at least Luggage Control Means of the season at their destination). Preparation, and/or editing, and/or use, of one at least Personal Selection Means preferably may be facilitated by one at least User Controlled Data Processing Means and/or one at least Internet Means.

Part at least of information entry into and/or information output from one at least Luggage Control Means preferably may be facilitated by one at least User Controlled Data Processing Means (e.g. PC) and/or the Internet, as non-limiting examples.

The means described in the present specification and/or in said PCT AU 03/01029 incorporated by reference, may be readily modified by those experienced in the art to provide part at least of the functions of one at least Luggage Control Means. One at least Luggage Control Means preferably may transfer information to and/or from one at least other means. Said other means preferably may include one at least second Luggage Control Means and/or User Controlled Data Processing System and/or Internet Means. As a non-limiting example said transfer information may be to backup and/or restore information to/from said other means. Said information transfer preferably may include wireless and/or wired means (e.g. one at least means described to transfer information into and/or out of one at least Sock Control Means).

In one preferred embodiment, the Sock Control Means preferably may be programmed to provide the functions of one at least Luggage Control Means. As a non-limiting example, one at least persons may hand scan one at least Luggage ID Means (preferably coupled to one at least luggage items) of luggage items using a suitably adapted SCM as Luggage Items are packed and/or unpacked.

As a non-limiting example, one at least Luggage Control Means preferably may be included, in part at least, in one at least Luggage Carrying Means. For example, one at least RFID antenna and/or reader means may be fabricated within part of said Luggage Carrying Means (e.g. suitcase lid and/or suitcase base and/or sides). One at least Luggage Control Means preferably may read one at least Luggage ID means in real time during packing and/or unpacking of one at least Luggage Items. It is preferable that there is a means (preferably wireless) to communicate between parts of the invention coupled to one at least Luggage Carrying Items and one at least external means. Said wireless means preferably may include one at least of those described elsewhere in this specification.

The known art describes Baggage Tracking Means, wherein, one at least Luggage Carrying Means is tagged with an RFID transponder that may be tracked through transport systems (e.g. airports/aircraft). The invention preferably allows that one at least Luggage Control Means (for example, integrated with one at least known art Baggage Tracking Means) preferably may be used to track the contents of said Luggage Carrying Means through one at least transport systems. For example, when luggage is checked into an airport, the contents preferably may be electronically recorded by the airline. This may be checked at one or more points in the journey (e.g. by the owner and/or airline) to verify that part at least of contents have not gone missing by accident and/or intent. It is preferably that access to Luggage ID Means may be restricted in part at least (e.g. during part at least of said transport system).

Enhanced airport security because of terrorist concerns, is increasing the frequency that luggage is being opened and physically examined. As a non-limiting example, the luggage tracking means of the present invention preferably may reduce the likelihood of personal effects being misplaced during said examination.

It is a preferred objective of the present invention to allow for the manufacture, and/or distribution, and/or sale, and/or rent, and/or advertising, and/or transfer from a first to a second jurisdiction, of part at least of the means described in this specification.

It is a preferred objective of the present invention to allow for the attachment of one at least Sock ID Means, particularly one at least electronic Sock ID Means, to one at least socks. One at least Sock ID Means preferably may include descriptive information (e.g. ASCII coding). Said descriptive information preferably may be programmed. Said descriptive information preferably may be edited. One at least Sock ID Means preferably may be attached to one at least socks during the manufacture and/or distribution and/or retail phase. One at least Sock ID Means preferably may be sold and/or otherwise provided to one at least users unattached to a sock. One at least Sock ID Means preferably may be attached to one at least socks by one at least consumers.

It is a preferred objective of the present invention to allow for the attachment of one at least Luggage ID Means to one at least Luggage Items. One at least Luggage ID Means preferably may include descriptive information (e.g. ASCII coding) about its coupled Luggage Item(s). Said descriptive information preferably may be programmed. Said descriptive information preferably may be edited. One at least Luggage ID Means preferably may be attached to one at least Luggage Items during the manufacture and/or distribution and/or retail phase. One at least Luggage ID Means preferably may be sold and/or otherwise provided to one at least users unattached to a Luggage Item. One at least Luggage ID Means preferably may be attached to one at least Luggage Items by one at least consumers.

It is a preferred objective of the present invention to allow for the attachment of one at least Suitcase ID Means to one at least Luggage Carrying Means, that preferably may be used to electronically tag said Luggage carrying Means. One at least Suitcase ID Means preferably may include descriptive information (e.g. ASCII coding) about its coupled Luggage Carrying Means (e.g. Red Suitcase belong to Fred Jones). Said descriptive information preferably may be programmed. Said descriptive information preferably may be edited. One at least Suitcase ID Means preferably may be attached to one at least Luggage Carrying Means during the manufacture and/or distribution and/or retail phase. One at least Suitcase ID Means preferably may be sold and/or otherwise provided to one at least users unattached to a Luggage Carrying Means. One at least Suitcase ID Means preferably may be attached to one at least Luggage Carrying Means by one at least consumers.

One at least Sock Control Means, and/or Luggage Control Means, and/or Location Control Means, are preferably coupled to one at least Power Source Means (e.g. battery). Said Power Source Means preferably may be rechargeable.

One at least RFID transponder means and/or RFID Reader Means preferably may be:—a) read and/or write; and/or b) able to facilitate cryptographic processes; and/or c) operate on one at least of i) frequencies in the 100 KHz-150 KHz band, ii) 13 MHz-14 MHz range (e.g. 13.56 MHz), iii) 800 MHz-970 MHz range), iv) 2.3-2.5 GHz range (e.g. bluetooth and/or zigbee frequencies); and/or d) able to be deactivated (preferably reversibly).

The invention preferably allows that one at least Electronic Means that requires user input and/or provides output to one at least users may include user programmable options. Non-limiting examples of said electronic means preferably may include one at least of:—
Key Control Means (e.g. as described in said PCT AU 03/01029); Sock Control Means; Location Control Means; Luggage Control Means, Personal Communication Means (e.g. cellular telephone).

Said user programmable options preferably may include one at least of the following non-limiting examples:—
a) user determination of the:—
   i) function of one at least keys, and/or
   ii) the sequence of two at least keys, and/or
   iii) the time one at least keys may stay pressed and/or
   iv) the time that one at least keys may remain inactive, and/or
   v) preferably one at least commands that may be facilitated by one at least keyboard actions.
b) user determination of:—
   i) the characters and/or symbols and/or graphics used to display one at least menu means on one at least displays; and/or
   ii) one at least commands and/or sequence of commands associated with said display means; and/or
   iii) the sequencing of one at least menu means.
c) user determination of:—
   i) one at least words and/or phrases to be used as input voice commands; and/or
   ii) one at least commands that may be facilitated by said one at least words and/or phrases.
d) user determination of one at least words and/or phrases to be used as output sounds.

One at least said electronic means preferably may be programmed with options for a first person and one at least options for one at least second persons, wherein one at least option for said first person preferably may vary compared to one at least options for said second person.

User entry of and/or editing of one at least options preferably may be facilitated by one at least computer programs executing for example on one at least of:—
i) Said Electronic Means;
ii) One at least User Controlled Data Processing Means; and/or
iii) One at least Internet Means (as a non-limiting example of a network means).

### PREFERRED EMBODIMENT OF THE INVENTION

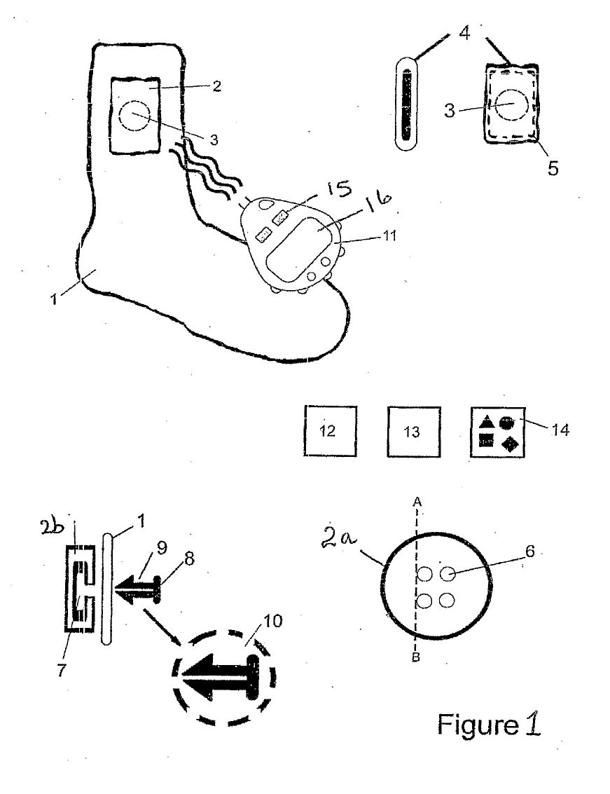

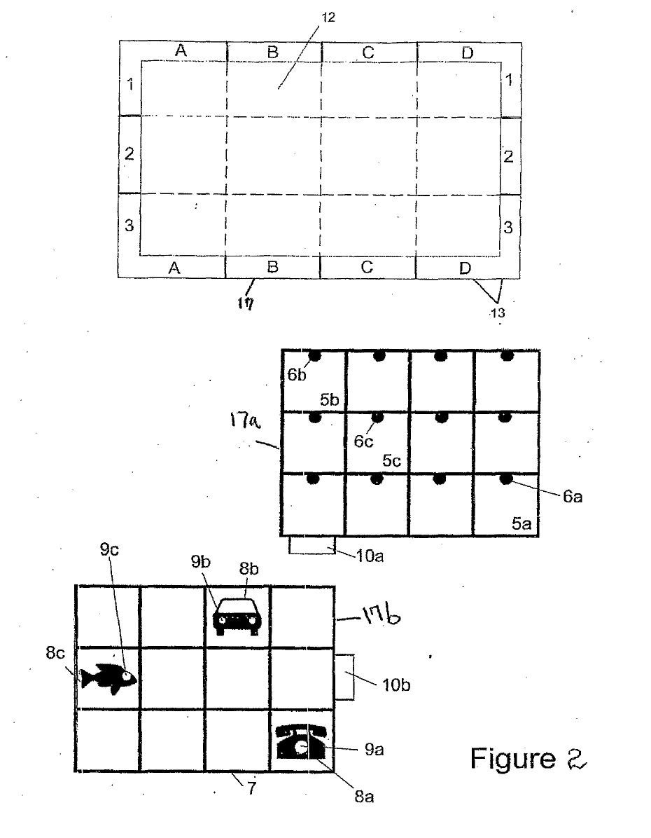

FIG. 1 of the drawings depicts examples of devices that preferably may be used to provide a sock ID device. The sock 1 is shown with a fabric tag 2 attached, said tag preferably enclosing an electrically readable device 3 and/or an indicia means 14 (e.g. shapes, colours) on a visible surface of said tag. Plan and cross-section of said tag is depicted in 4. The electrically readable device preferably includes RFDI transponder 12 and/or Onewire device 13. Electrically operable device 11 preferably may read the sock id information (e.g. digital camera to machine read indicia, RFID reader, Onewire reader). Said device 11 preferably may have information (e.g. indicia information) entered manually (e.g. using a keyboard). it is preferably coupled to an electrically operable display 16. Device 11 preferably may interface (e.g. wired, RF, infrared) with electrically operable means coupled to a sock sorting apparatus (e.g. 17a, 17b, 17c, 17d, of FIGS. 2 & 3). Said electrically operable device is preferably coupled to a computer (e.g. microprocessor), computer readable media, and digital content stored in said memory (e.g. programs and/or data). An example alternative to the fabric tag 1 is depicted in Sock ID 2a that is a plastic (or similar) disc for attachment to said sock using holes 6 (e.g. sewn with thread). Another example is sock ID 2b that includes a receptacle for pin 8 to snap into, preferably being locked in place by arrangement 9 and clamping sock 1 between 2b and 8.

FIG. 2 of the drawings depicts examples of the sock storage apparatus that are preferably temporary storage locations for socks during the sorting and/or mating of socks. An example of the alphanumeric grid sock storage 17 is shown with grids 12 identified by letters on the x-axis and numbers on the y axis. Sock storage apparatus 17a depicts a device that is divided into a number of areas 5a, 5b, 5c, each area associated with an indicator device 6a, 6b, 6c. The electronics 10a to control said indicator devices is also shown. This preferably interfaces to electrically operable device 11 of FIG. 1 and/or provides part at least of the functions of said device 11. Non-limiting examples of the sock storage apparatus of 17, 17a, 17b are preferably part of one at least items of Manchester and, throw over, and/or mat, and suitable flexible and/or rigid approximately flat apparatus. Sock storage device 17b depicts a similar arrangement to 17a, however a number of images are included (e.g. fish 8c and indicator device 9c as its eye, car 8b and indicator device 9b as a headlight, telephone 8a and indicator device 9a as the dial) with support electronics depicted as 10b.

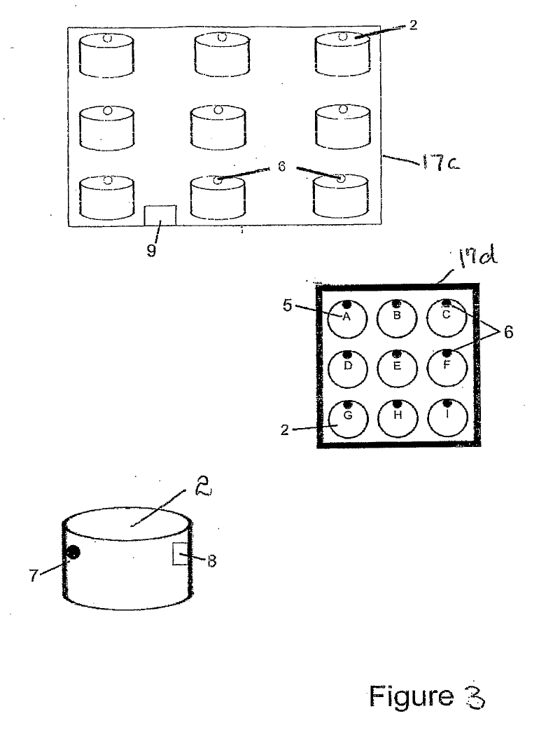

FIG. 3 of the drawings depicts examples of sock storage apparatus that preferably may facilitate sock sorting mating and also act as a sock storage means pending use of said socks. For example, these preferably may include a suitably fabricated drawer 17d or a wall mounted unit 17c. Unit 17c shows receptacles 2 mounted to a vertical support structure. The indicator devices are shown as 6. There is preferably a means to detect the presence or absence of sock(s) in one at least storage locations 2, for example IR emitter 7 and IR detector 8.

It is understood that variations in the figures or described elsewhere in this specification are for illustrative purposes only and that many other variations will be apparent to one skilled in the art. It will also be understood that the specification and figures are illustrative of the present invention and that other embodiments within the spirit and scope of the invention will suggest themselves to those skilled in the art.

1-98. (canceled)

99. A method for facilitating the mating of members of a plurality of garments the mated members forming a matched set wherein the method comprises:—
providing an identifiable location to place a first and or second member of a first matched set;
providing an identifiable location to place a first and or second member of a second matched set;
inputting into an electrically operable device identifying information associated with a member;
processing the member identifying information;
outputting a signal from an electrically operable device facilitating user determination of the identifiable location to place said member;
wherein said garments preferably comprise socks and a matched set preferably comprises a pair of socks.

100. The method for facilitating the mating of members as claimed in claim 99, wherein the identifiable location related to at least one member of the first matched set is distinct to the identifiable location related to at least one member of the second matched set.

101. The method for facilitating the mating of members as claimed in claim 99 wherein at least one identifiable location is identified by an identifier that is human readable, said location identifier preferably comprising at least one of indicia, shapes, colours, images.

102. The method to mating members as claimed in claim 99 wherein the location to place said member is identified by an electrically operable indicator and preferably wherein said indicator is proximal to said location.

103. The method for facilitating the mating of members as claimed in claim 102 wherein a first electrically operable indicator is associable with a first location to place one at least members of a first matching set and a second electrically operable indicator is associable with a second location to place one at least members of a second matching set.

104. The method for facilitating the mating of members as claimed in claim 103 wherein the first indicator is operable to alter state in response to an electrically operable device receiving information associated with a member of the first matching set and or the second indicator is operable to alter state in response to an electrically operable device receiving information associated with a member of the second matching set.

105. The method for facilitating the mating of members as claimed in claim 99 wherein the identifiable location related to one at least members of a first matching set is associable with a first person and the identifiable location related to one at least members of a second matching set is associable with a second person.

106. The method for facilitating the mating of members as claimed in claim 99 wherein a first electrically operable indicator associated with a first identifiable location facilitates the transfers of at least one said member to a second identifiable location and preferably wherein said transfer is from a temporary storage arrangement to an extended storage arrangement.

107. The method for facilitating the mating of members as claimed in claim 106 wherein a second electrically operable indicator associated with said second identifiable location facilitates said transfer.

108. An electrically operable system for facilitating the mating of members of a plurality of socks the mated members forming a matched set.

109. The electrically operable system for facilitating the mating of members as claimed in claim 108 further comprising a portable electronic device for receiving identifying information from said members and for electronically outputting information facilitating the mating of members.

110. The electrically operable system for facilitating the mating of members as claimed in claim 108 wherein said system is for use with members in a user environment.

111. The electrically operable system for facilitating the mating of members as claimed in claim 108 further arranged to receive information pertaining to identifying information coupled to the member.

112. The electrically operable system for facilitating the mating of members as claimed in claim 111 wherein the identifying information comprises a bar code, indicia, shape or colour, and preferably wherein the identifying information is coupled to the sock by at least one of:
printing,
woven into the fabric of the sock,
a device attached to the sock.

113. The electrically operable system for facilitating the mating of members as claimed in claim 111 wherein the received information comprises at least one of: voice input, keyboard entry, selection from a means for display, pointing device, wireless input, electronic imaging.

114. The electrically operable system for facilitating the mating of members as claimed in claim 111 wherein the received information is manually entered and or electronically read into the system.

115. The electrically operable system for facilitating the mating of members as claimed in claim 114 wherein the identifying information is electronically read by RFID or the transfer of power and data on a single conductor.

116. The electrically operable system for facilitating the mating of members as claimed in claim 108 arranged to receive first identifying information pertaining to a first member and second identifying information pertaining to a second member, wherein said first and second members are a mating pair, and said first and second identifying information is stored in computer memory and the system preferably further arranged to associate said stored first and second identifying information.

117. The electrically operable system for facilitating the mating of members as claimed in claim 116 further arranged to receive at a subsequent time said first and or second identifying information and to process the subsequently received identifying information with the previously stored identifying information.

118. The electrically operable system for facilitating the mating of members as claimed in claim 117 further comprising an output signal responsive to said processing, said output signal facilitating mating of the member associated with said identifying information.

119. The electrically operable system for facilitating the mating of members as claimed in claim 118 wherein the output signal facilitates activation of an electrically operable indicator associated with a location for a user to place said member.

120. The electrically operable system for facilitating the mating of members as claimed in claim 108 further comprising at least one of: sock ID means, passive sock storage means, active sock storage means, sock location ID means, sock storage means, vacant sock location detector means, sock control means, sock ID acquisition means, sock ID library means, sock ID support information, and or active sock processing means.

121. The method of coupling identifying information to a sock wherein the information is for use with an electrically operable system arranged to facilitate the mating of members of a plurality of socks the mated members forming a matched set.

122. An item of bedding for sorting and or mating members of a plurality of members, the mated members forming a matched set wherein the item of bedding is arranged to provide a first signal for association with a first member and a second signal for association with a second member and preferably wherein: said members comprise socks, and or said bedding includes at least one of blanket, bed sheet, doona cover, or bedspread.

123. An item of bedding as claimed in claim 122 wherein the first signal is provided by a first electrically operable indicator and the second signal is provided by a second electrically operable indicator, both indicators coupled to the item of bedding.

124. An item of bedding as claimed in claim 123 wherein the first signal is for activation in response to the provision of information related to a first member and the second indicator is for activation in response to the provision of information related to a second member.

125. An electrically operable system for tracking at least one of:
the placement of an item into luggage;
the presence of an item stored in the luggage;
the removal of an item from luggage;
wherein
the system is arranged to read an identifying signal coupled to the item; and
preferably wherein:
said luggage comprise at least one of: a suitcase, briefcase, handbag or baby pack; and or
said item comprise at least one of: garment, toothbrush, razor, deodorant, diapers, documents, electronic device.

126. An electrically operable system for tracking as claimed in claim 125 further comprising an RFID reader, the reader preferably arranged to read said identifying signal from an RFID transponder attached to said item.

127. An electrically operable system for tracking as claimed in claim 125 further comprising at least one of: a Luggage Control Means, Personal Selection Means, Luggage ID Means or a Suitcase ID Means and preferably wherein the Luggage ID Means and or Suitcase ID Means includes an RFID device.

128. An electrically operable system for tracking as claimed in claim 127 wherein said RFID device is arranged to be inactivated, said inactivation preferably reversible.

129. A portable electrically operable device arranged to:
receive user commands by keyboard entry, selection from a display, or voice input; and or
output information on a display;
wherein,
the portable device is further arranged to provide for user customisation of:
the input required to elicit a command; and or
the sequence of menu items displayed in response to user input.

130. A portable electrically operable device as claimed in claim 129 wherein the device is further arranged to store customisation information for first and second users, said first and second customisation information independently configurable.
